(19) United States
(12) Patent Application Publication
(10) Pub. No.: US 2018/0024768 A1
(43) Pub. Date: Jan. 25, 2018

(54) PARTITIONING MEMORY MODULES INTO VOLATILE AND NON-VOLATILE PORTIONS

(71) Applicant: Hewlett Packard Enterprise Development LP, Houston, TX (US)

(72) Inventors: Vincent Nguyen, Houston, TX (US); Jeffrey A. Plank, Cypress, TX (US); Hai Ngoc Nguyen, Spring, TX (US); Han Wang, Sugar Land, TX (US); Patrick A. Raymond, Houston, TX (US); Raghavan V. Venugopal, Spring, TX (US); Barry L. Olawsky, Houston, TX (US)

(21) Appl. No.: 15/549,724

(22) PCT Filed: Feb. 13, 2015
(86) PCT No.: PCT/US2015/015973

§ 371 Date: Aug. 9, 2017

(51) Int. Cl. G06F 3/06

(52) U.S. Cl. CPC G06F 3/0644; G06F 3/0619; G06F 3/0647; G06F 3/0679

(57) ABSTRACT

Example implementations relate to partitioning memory modules into volatile and non-volatile portions. For example, a system includes a memory controller to partition a memory module into a non-volatile portion and a volatile portion and to identify persistent data to be backed up during a power loss condition. The memory controller is further to transfer the persistent data from the volatile portion of the memory module to the non-volatile portion of the memory module, in response to the power loss condition.

### BACKGROUND

As reliance on computing systems continues to grow, so too does the demand for reliable memory including memory capable of storing persistent data in the event of a power loss. In addition, there is an increased demand for reliant power systems and backup schemes for these computing systems. Servers, for example, may provide architectures for backing up data to flash or persistent memory as well as backup power sources for powering the data backup.

### BRIEF DESCRIPTION OF THE DRAWINGS

Some examples of the present application are described with respect to the following figures:

FIG. 1 is a block diagram of a system to partition a memory module into a non-volatile portion and a volatile portion, according to an example;

FIG. 2 is a block diagram of a system to partition a memory module into a non-volatile portion and a volatile portion, according to an example;

FIG. 3 is a flowchart illustrating a method for partitioning a subset of memory modules into non-volatile and volatile portions, according to an example;

FIG. 4 is a flowchart illustrating a method for partitioning a subset of memory modules into non-volatile and volatile portions, according to an example; and

FIG. 5 is a block diagram of a computer-readable storage medium having instructions executable to partition a subset of memory modules into non-volatile and volatile portions, according to an example.

### DETAILED DESCRIPTION

A computing system such as a server may support large numbers of memory modules (e.g., a dual in-line memory module (DIMM)), and include a basic input/output system (BIOS) that may group volatile and non-volatile memory into different segments. However, applications to be run on the server may be allocated a single segment (linear region of memory) by the system, despite a desire to provide backup memory support to the application. Further, a small portion of the total information or data stored in the DIMMs is to be retained after a loss of power to the system. Providing backup power to all of the DIMMs in order to retain a small amount of data may result in inefficiencies, given the finite amount of backup power.

Examples described herein may avoid such inefficiencies, by enabling support of volatile and non-volatile portions within a given memory module. Further, creating a subset of DIMMs having both volatile and non-volatile portions for which a finite amount of backup power is available after loss of power to the system can result in a more efficient use of backup power. As applications evolve to utilize non-volatile memory in addition to volatile memory, a solution to divide or partition the memory stack into volatile and non-volatile blocks not directly aligned with physical DIMMs boundaries will be beneficial. Accordingly, portions of any single DIMM may be volatile or non-volatile, thereby avoiding a need for a memory module to be only one of a volatile memory or a non-volatile memory.

In one example, a system includes a memory controller to partition a memory module into a non-volatile portion and a volatile portion. The memory controller is to identify persistent data to be backed up during a power loss condition and to transfer the persistent data from the volatile portion of the memory module to the non-volatile portion of the memory module, in response to the power loss condition.

In another example, a method includes partitioning, by a memory controller, a subset of a plurality of memory modules into non-volatile portions and volatile portions and identifying persistent data to be backed up in response to an interruption of primary power supply to the plurality of memory modules. The method includes moving, by the memory controller, the persistent data from the volatile portions of the plurality of memory modules to the non-volatile portions of the plurality of memory modules, in response to the interruption of primary power supply, using backup power provided by a backup power supply.

In another example, a non-transitory computer-readable storage medium encoded with instructions executable by a processor of a computing system includes instructions to partition a subset of a plurality of memory modules into non-volatile portions and volatile portions, and to identify persistent data to be backup up from the volatile portions of the plurality of memory modules in response to a power loss condition. The computer-readable storage medium also includes instructions executable to copy the persistent data from the volatile portions to the non-volatile portions of the plurality of memory modules in response to the power loss condition, using backup power from a backup power supply.

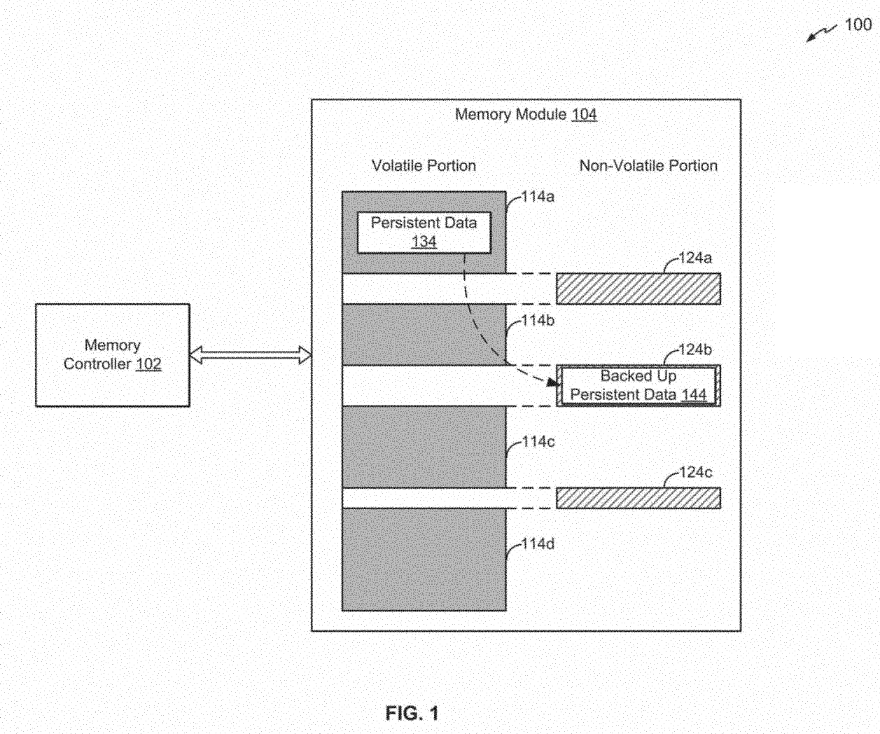

Referring now to the figures, FIG. 1 is a block diagram of a system to partition a memory module into a non-volatile portion and a volatile portion, according to an example. System 100 can be any type of computing system such as a portable computer or communication device, a standalone server computer, a blade server, etc. System 100 can include a memory controller 102 coupled to a memory module 104. System 100 can include additional components such as embedded firmware and hardware components. For example, system 100 can include a central processing unit (CPU), power supply, display, other hardware, software application, a plurality of input/output (I/O) ports, etc.

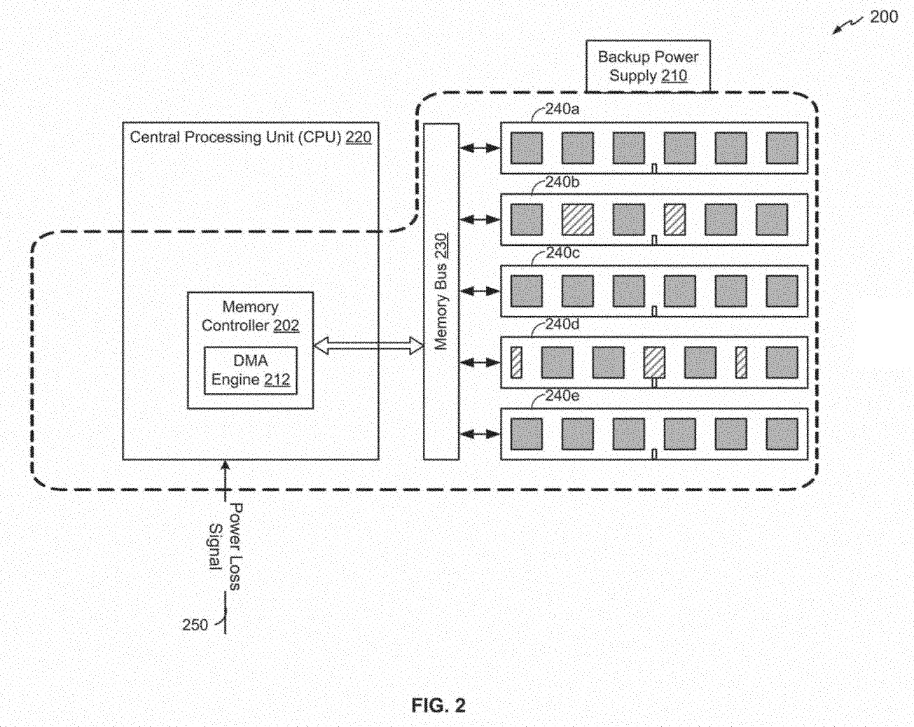

Memory controller 102 can be a device that manages the memory module 104. For example, memory controller 102 can generally coordinate data access/flow in the memory module, including identifying locations of persistent data (e.g., persistent data 134) and non-persistent data in the memory module. In some examples, memory controller 102 can include a direct memory access (DMA) engine (shown in FIG. 2) and functionality described by the memory controller 102 can be provided by the DMA engine. Memory controller 102 can be implemented in software, firmware and/or hardware.

Memory controller 102 can partition the memory module 104 into a volatile portion (i.e., memory blocks 114a, 114b, 114c, 114d, collectively referred to herein as volatile portion 114) and a non-volatile portion (i.e., memory blocks 124a, 124b, 124c, collectively referred to herein as non-volatile portion 124). Partitioning of the memory module into volatile portion 114 and non-volatile portion 124 can be based at least in part on a capacity of a backup power supply to successfully provide backup power to back up the persistent data 134, a size of the memory module 104, a type of application currently running on the system 100, and requirements of the system 100 (e.g., system configuration). In various examples, a size of the non-volatile portion 124 of the memory module 104 is less than a size of the volatile portion 114 of the memory module 104. In some examples, the memory module 104 is pre-configured and partitioned into the volatile portion 114 and the non-volatile portion. However, in other examples, the partitioning is performed dynamically (i.e., during runtime). Accordingly, the memory module 104 can be both volatile and non-volatile.

Memory controller 102 can identify persistent data to be backed up during a power loss condition or an interruption of primary power supply. Memory controller 102 can use metadata information such as characteristics, address, location, etc. to identify persistent data 134 to be backed up. In some examples, memory controller 102 may use a tracking software (e.g., a metadata engine) to keep track of persistent data 134 that are to be backed up, and stored as metadata. In other examples, memory controller 102 may use a caching procedure to identify areas of the memory module 104 that are to be backed up. In such an example, areas (e.g., memory block 114a) may be identified in the metadata as having passed through the static random access memory (SRAM) of the system's CPU. In yet other examples, identification of the persistent data 134 can be based in part on the capacity of the backup power supply to successfully provide backup power to enable the transfer of the persistent data 134. Other approaches may be used to flag persistent data 134 and store the corresponding identification information. Such techniques can be applied dynamically in real-time during operation of the system 100. In alternate examples, the memory controller 102 may periodically check for any updates to what data is to be considered persistent, and its corresponding locations.

In various examples, persistent data 134 may not be from contiguous memory addresses in the memory module 104, and may be located at disparate memory locations throughout the memory module 104. Thus, specific portions of the memory module 104 may be identified as containing persistent data 134 and targeted for backup (e.g., according to the metadata), whether located in blocks 114a, 114b, 114c, 114d, or other non-contiguous locations of the volatile portion of the memory module 104. In other examples, the persistent data 134 can be physically located in another memory module different from the memory module 104 (e.g., either on a portion of the other memory module or occupy an entirety of the other memory module), or may be located throughout systems across multiple geographic locations.

Memory controller 102 can transfer the persistent data 134 from the volatile portion 114 of the memory module 104 to the non-volatile portion 124 of the memory module 104, in response to the power loss condition. In response to a power loss condition (e.g., blackout or other interruption to delivery of power to the system 100), the memory controller 102 can copy/move/transfer the persistent data 134 to the non-volatile portion 124 of the memory module 104, using backup power provided by the backup power supply. Accordingly, when the power loss condition occurs, the non-volatile portion 114 of the memory module will include backed up persistent data 144.

Although backed up persistent data 144 is shown as a single block of data, examples are not so limiting. Backed up persistent data 144 may be spread as multiple blocks throughout multiple non-volatile portions 124 of the memory module 104. Memory controller 102 can keep track of the addresses of the backed up persistent data 144, for example using metadata, and the metadata may serve as a data pointer. The metadata can also be stored, along with the backed up persistent data 144, in the non-volatile portion 124 of the memory module 104. In some examples, the metadata can be provided as a descriptor table, a linked list of descriptors, and so on.

FIG. 2 is a block diagram of a system to partition a memory module into a non-volatile portion and a volatile portion, according to an example. System 200 includes a memory controller 202, a memory bus 230, a backup power supply 210, and a plurality of memory modules (i.e., memory modules 240a, 240b, 240c, 240d, and 240e, collectively referred to herein as memory modules 240). The memory controller 202 can include a DMA engine 212 and can form at least a portion of the CPU 220, which may receive a power loss signal 250. The memory controller 202 is coupled to the memory bus 230, which is coupled to the plurality of memory modules 240. The DMA engine 212 can be the portion of the memory controller 202 responsible for memory access including data transfer/copy/move. For example, the DMA engine 212 can allow access to the memory modules 240 directly, independent of the CPU 220. Backup power supply 210 is to provide backup power to the memory controller 202, memory bus 230 and the memory modules 240 (the backup power supply domain shown enclosed in dashed lines).

In the example of FIG. 2, the memory controller can partition a subset of the memory modules 240 into non-volatile portions and volatile portions. For example, memory modules 240b and 240d can be partitioned into non-volatile portions (depicted in blocks having diagonal patterns) and volatile portions (depicted in shaded blocks), while memory modules 240a, 240c, and 240e may only include volatile portions. Accordingly, memory modules 240b and 240d include both non-volatile portions and volatile portions. Thus, system 200 can include a plurality of memory slots that are occupied by persistent capable memory modules (e.g., 240b and 240d) each having portions assigned as persistent, and other memory modules (e.g., 240a, 240c, and 240e) that may or may not support the persistent feature and are currently configured as volatile.

The backup power supply 210 can be used to perform backups, for example, in response to a power loss condition. For example, the CPU 220 may receive a power loss signal 250 indicating a power loss. Upon loss of power to the system 200, the backup power supply 210 may serve as a local finite power source to provide enough energy to continue to allow the CPU's memory controller 202 (including the DMA engine 212) to transfer the persistent data from the volatile portions of the memory modules 240 to the non-volatile portions of the memory modules 240, as described above. Thus, the backup power supply 210 may provide enough energy to power at least the memory controller 202 (and the DMA engine 212), the memory bus 230, and the memory modules 240. Additional modules (not specifically shown) within the CPU 220 may also be powered as needed.

Backup power supply 210 can be an energy component to convert stored energy to electrical energy to deliver power to components described above. Examples of backup power supply 210 can include, but are not limited to, a rechargeable battery, a capacitor (e.g., supercapacitor, ultracapacitor, etc.), a flywheel, and the like. A capacity of the backup power supply 210 can be chosen based on parameter/considerations including total power needs of the CPU 220 and memory modules 240 during the data transfer process, the finite period of time which backup power is to be available, the maximum number of memory modules having non-volatile portions to be supported, and any additional signals needed by the memory modules' connector interface and/or which memory pins are repurposed, if applicable, and so on.

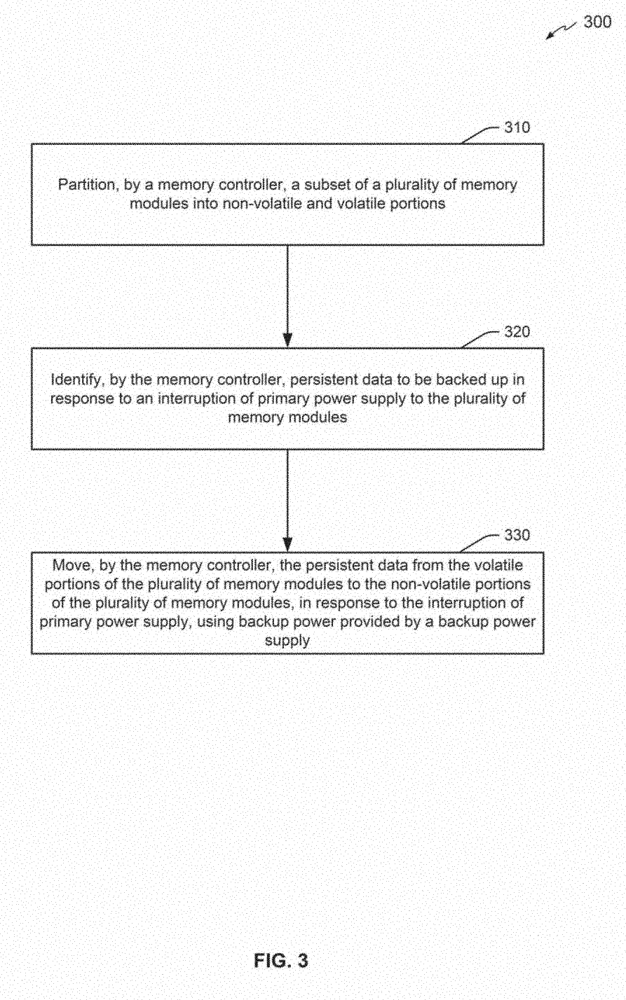

FIG. 3 is a flowchart illustrating a method for partitioning a subset of memory modules into non-volatile and volatile portions, according to an example Method 300 can be implemented, for example, in the form of executable instructions stored on a non-transitory computer-readable storage medium and/or in the form of electronic circuitry. The example method 300 will now be described with further reference to FIG. 1 and/or FIG. 2.

Method 300 includes partitioning, by a memory controller, a subset of a plurality of memory modules into non-volatile and volatile portions, at 310. For example, memory controller 202 can partition a subset of the memory modules 240 (e.g., memory modules 240b and 240d) into regions including both volatile portions and non-volatile portions. In various examples, the partitionable memory modules 240b and 240d can include flash components to support non-volatile features. In other examples, the partitionable memory modules 240b and 240d can include a secondary memory controller (e.g., a limited functionality memory controller) on board each memory module 240b and 240d to move the persistent data from the volatile portion to the non-volatile portion. Accordingly, a remainder of the memory modules may not support non-volatile features and may only include volatile portions (e.g., memory modules 240a, 240c, and 240e).

Method 300 includes identifying, by the memory controller, persistent data to be backed up in response to an interruption of primary power supply to the plurality of memory modules, at 320. For example, memory controller 202 can use a caching procedure to identify areas of the memory modules 240 that are to be backed up (i.e., identify persistent data in the memory modules 240). In an example, such areas may be identified according to identifying data that has passed through the SRAM of the CPU 220. Other techniques may be used to flag persistent data and store the corresponding identifying information. Such techniques may be applied dynamically in real-time during operation. In other examples, the memory controller may periodically check for any updates to what data is to be considered persistent and its corresponding location.

Method 300 includes moving, by the memory controller, the persistent data from the volatile portions of the plurality of memory modules to the non-volatile portions of the memory modules, in response to the interruption of primary power supply, using backup power provided by a backup power supply, at 330. For example, memory controller 202 can receive a power loss signal 250 indicating a power loss condition has occurred. In response to the power loss condition, memory controller can move the persistent data from any of the volatile portions of the memory modules 240 to the non-volatile portions of the memory modules 240, using backup power provided by the backup power supply 210. Accordingly, persistent data can be moved from any contiguous or non-contiguous memory block across any location in the memory modules to the non-volatile portions (which may also be located in any of the memory modules 240 according to the partitioning). In some examples, the method 300 of FIG. 3 includes additional steps in addition to and/or in lieu of those depicted in FIG. 3.

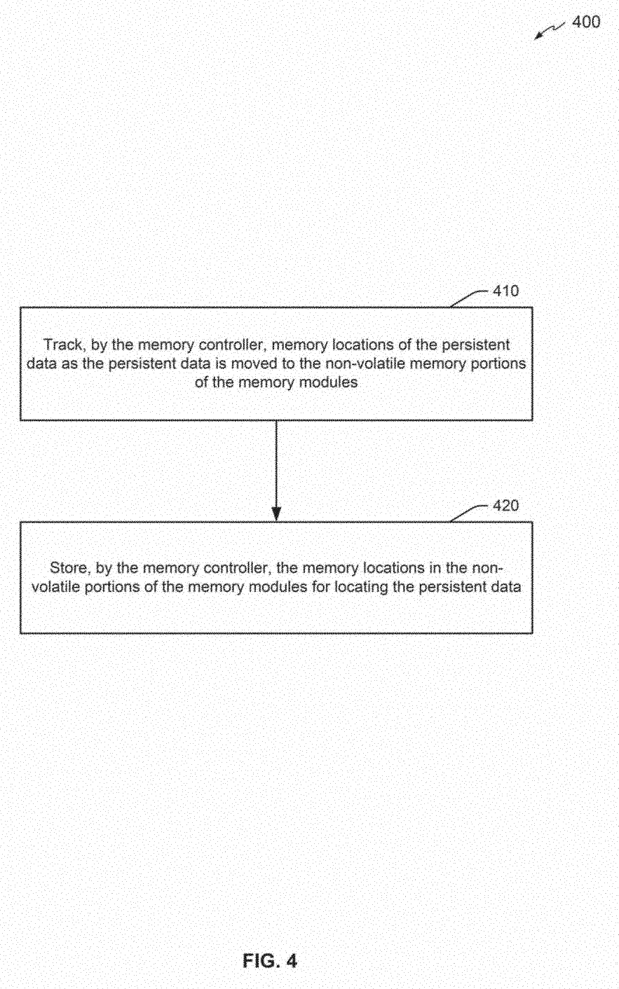

FIG. 4 is a flowchart illustrating a method for partitioning a subset of memory modules into non-volatile and volatile portions, according to an example Method 400 can be implemented, for example, in the form of executable instructions stored on a non-transitory computer-readable storage medium and/or in the form of electronic circuitry. The example method 400 will now be described with further reference to FIG. 1 and/or FIG. 2.

Method 400 includes tracking, by the memory controller, memory locations of the persistent data as the persistent data is moved to the non-volatile memory portions of the memory modules, at 410. For example, the memory controller can use a tracking software to keep track of persistent data that are to be backed up. Memory controller can use any other data tracking techniques and keep track of the addresses of the backed up persistent data, for example using metadata, where the metadata can serve as a data pointer.

Method 400 includes storing the memory locations in the non-volatile portions of the memory modules to locate the persistent data, at 420. For example, the memory controller can store the tracking information (e.g., metadata) in the non-volatile portion or on a storage device available to the memory controller, such that the persistent data can be located. In some examples, the method 400 of FIG. 4 includes additional steps in addition to and/or in lieu of those depicted in FIG. 4.

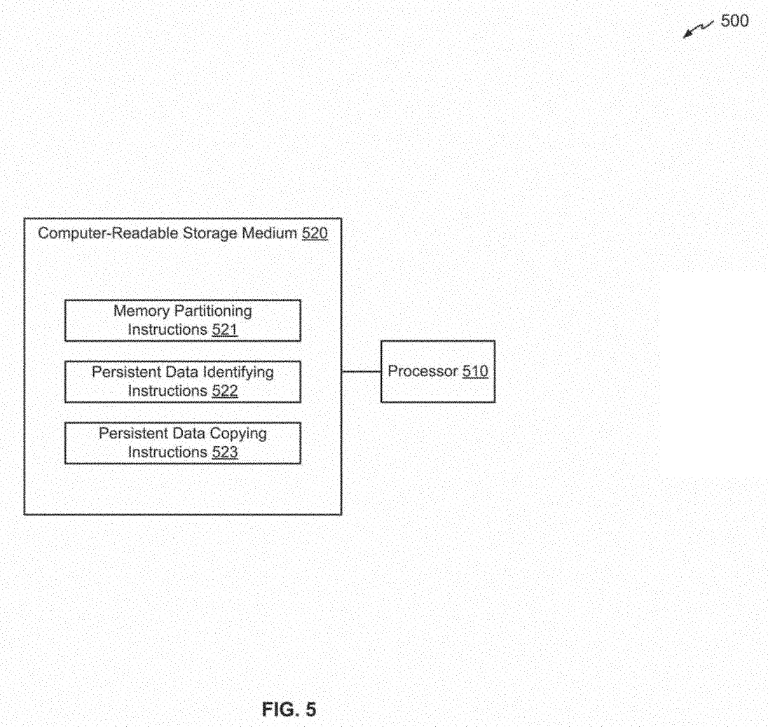

FIG. 5 is a block diagram of a computer-readable storage medium having instructions executable to partition a subset of memory modules into non-volatile and volatile portions, according to an example. Computer-readable medium 520 may be any electronic, magnetic, optical, or other physical storage device that stores instructions executable by a processor 510 of a computing system 500. Thus, computer-readable storage medium 520 may be, for example, random access memory (RAM), an electrically-erasable programmable read-only memory (EEPROM), a storage drive, an optical disc, and the like. As described in detail below, computer-readable storage medium 520 may be encoded with executable instructions for partitioning a subset of memory modules into non-volatile and volatile portions.

Memory partitioning instructions 521 include instructions to partition a subset of a plurality of memory modules into non-volatile portions and volatile portions. For example, the instructions can be executable to partition a group of memory modules, such as DIMMs, into portions including volatile portions and non-volatile portions. Thus, any DIMM in the group will include both a volatile portion and a non-volatile portion.

Persistent data identifying instructions 522 include instructions to identify persistent data to be backed up from the volatile portions of the plurality of memory modules in response to a power loss condition. For example, the instructions can be executable to identify data in various areas of the memory modules to be backed up. Identification of the persistent data can be in real-time, for example

Persistent data copying instructions 523 include instructions to copy the persistent data from the volatile portions to the non-volatile portions of the plurality of memory modules in response to the power loss condition, using backup power from a backup power supply. The instructions 523 further include instructions to track memory locations of the persistent data copied to the non-volatile memory portions of the memory modules, and instructions to store the memory locations in the non-volatile portions of the memory modules to locate the persistent data.

The techniques described above may be embodied in a computer-readable medium for configuring a computing system to execute the method. The computer-readable media may include, for example and without limitation, any number of the following non-transitive mediums: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and the Internet, just to name a few. Other new and obvious types of computer-readable media may be used to store the software modules discussed herein. Computing systems may be found in many forms including but not limited to mainframes, minicomputers, servers, workstations, personal computers, notepads, personal digital assistants, tablets, smartphones, various wireless devices and embedded systems, just to name a few.

In the foregoing description, numerous details are set forth to provide an understanding of the present disclosure. However, it will be understood by those skilled in the art that the present disclosure may be practiced without these details. While the present disclosure has been disclosed with respect to a limited number of examples, those skilled in the art will appreciate numerous modifications and variations therefrom. It is intended that the appended claims cover such modifications and variations as fall within the true spirit and scope of the present disclosure.

What is claimed is:

1. A system, comprising:
a memory controller to:
partition a memory module into a non-volatile portion and a volatile portion;
identify persistent data to be backed up during a power loss condition; and
transfer the persistent data from the volatile portion of the memory module to the non-volatile portion of the memory module, in response to the power loss condition.

2. The system of claim 1, comprising a backup power supply to provide backup power to the memory module in response to the power loss condition, the backup power to enable the transfer of the persistent data to the non-volatile portion of the memory module.

3. The system of claim 2, wherein partition of the non-volatile portion of the memory module is based in part on a capacity of the backup power supply to successfully provide backup power to enable the transfer of the persistent data.

4. The system of claim 2, wherein identification of the persistent data is based in part on a capacity of the backup power supply to successfully provide backup power to enable the transfer of the persistent data.

5. The system of claim 1, wherein a size of the non-volatile portion of the memory module is less than a size of the volatile portion of the memory module.

6. The system of claim 1, wherein the memory module includes a dual in-line memory module (DIMM).

7. The system of claim 1, wherein the persistent data identified by the memory controller coexists in the memory module with non-persistent data in a single contiguous block, such that a memory space address map of the system is presented as a contiguous block including the persistent and the non-persistent portions.

8. The system of claim 1, wherein the memory controller is to transfer the persistent data from non-contiguous portions of the memory module and write the persistent data to the non-volatile portion in a contiguous sequential manner

9. The system of claim 1, wherein the memory controller is to track memory locations of the persistent data as the persistent data is transferred to the non-volatile portion, and to store the memory locations for locating the persistent data in the non-volatile portion.

10. A method, comprising:
partitioning, by a memory controller, a subset of a plurality of memory modules into non-volatile portions and volatile portions;
identifying, by the memory controller, persistent data to be backed up in response to an interruption of primary power supply to the plurality of memory modules; and
moving, by the memory controller, the persistent data from the volatile portions of the plurality of memory modules to the non-volatile portions of the plurality of memory modules, in response to the interruption of primary power supply, using backup power provided by a backup power supply.

11. The method of claim 10, comprising:
tracking, by the memory controller, memory locations of the persistent data as the persistent data is moved to the non-volatile memory portions of the memory modules; and
storing, by the memory controller, the memory locations in the non-volatile portions of the memory modules for locating the persistent data.

12. The method of claim 10, wherein partitioning the subset of the plurality of memory modules into non-volatile and volatile portions is based on a capacity of the backup power supply.

13. The method of claim 10, wherein the backup power supply is to provide backup power to the memory controller and the plurality of memory modules in response to the interruption of primary power supply for a threshold period of time.

14. A non-transitory computer-readable storage medium encoded with instructions executable by a processor of a computing system, the computer-readable storage medium comprising instructions to:
partition a subset of a plurality of memory modules into non-volatile portions and volatile portions;
identify persistent data to be backed up from the volatile portions of the plurality of memory modules in response to a power loss condition; and
copy the persistent data from the volatile portions to the non-volatile portions of the plurality of memory modules in response to the power loss condition, using backup power from a backup power supply.

15. The non-transitory computer-readable storage medium of claim 14, comprising instructions to:
track memory locations of the persistent data copied to the non-volatile portions of the memory modules; and
store the memory locations in the non-volatile portions of the memory modules to locate the persistent data.
